(19) United States
(12) Patent Application Publication
(10) Pub. No.: US 2024/0061079 A1
(43) Pub. Date: Feb. 22, 2024

(54) SCALABLE BIOMETRIC SENSING USING DISTRIBUTED MIMO RADARS

(71) Applicant: NEC Laboratories America, Inc., Princeton, NJ (US)

(72) Inventors: Mohammad Khojastepour, Lawrenceville, NJ (US); Eugene Chai, Monmouth Junction, NJ (US)

(21) Appl. No.: 18/452,690

(22) Filed: Aug. 21, 2023

Related U.S. Application Data
(60) Provisional application No. 63/399,745, filed on Aug. 22, 2022.

(51) Int. Cl. G01S 7/41; G01S 13/87; G01S 13/42

(52) U.S. Cl. CPC G01S 7/415; G01S 13/872; G01S 13/42

(57) ABSTRACT

Methods and systems for object localization include identifying associations between measurements taken from radar sensors. A shared coordinate system for the radar sensors is determined based the identified associations, including identifying translations and rotations between local coordinate systems of the radar sensors. A position of an object in the shared coordinate systems is determined, based on measurements of the object by the radar sensors. An action is performed responsive to the determined position of the object.

### RELATED APPLICATION INFORMATION

This application claims priority to U.S. Patent Application No. 63/399,745, filed on Aug. 22, 2022, incorporated herein by reference in its entirety.

### BACKGROUND

### Technical Field

The present invention relates to environment sensing and, more particularly, to the use of radar sensors to monitor environments.

### Description of the Related Art

Low-cost, low-power embedded radar sensors have proliferated in a variety of contexts. Radar systems can monitor signals in both line-of-sight and non-line-of-sight environments that are otherwise inaccessible to other sensing modalities. However, the fidelity of sensing data across a network of distributed radar sensors is limited by the degree of temporal and spatial coherency across the individual radar units. Obtaining precise positioning information for radar sensors is difficult, particularly when considering hundreds or thousands of sensors.

### SUMMARY

A method for object localization includes object localization include identifying associations between measurements taken from radar sensors. A shared coordinate system for the radar sensors is determined based the identified associations, including identifying translations and rotations between local coordinate systems of the radar sensors. A position of an object in the shared coordinate systems is determined, based on measurements of the object by the radar sensors. An action is performed responsive to the determined position of the object.

A system for object localization includes a hardware processor and a memory that stores a computer program. When executed by the hardware processor, the computer program causes the hardware processor to identify associations between measurements taken from radar sensors. A shared coordinate system for the radar sensors based the identified associations, including identifying translations and rotations between local coordinate systems of the radar sensors. A position of an object in the shared coordinate systems is determined, based on measurements of the object by the plurality of radar sensors. An action is performed responsive to the determined position of the object.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of a localization system, with object positions being monitored by a set of radar sensors, in accordance with an embodiment of the present invention;

FIG. 2 is a block/flow diagram of a method for localizing an object in an environment using multiple radar sensors, in accordance with an embodiment of the present invention;

FIG. 3 is a block diagram of a system for determining, and responding to, the position of an object in an environment, in accordance with an embodiment of the present invention;

FIG. 4 is a block diagram of a position detection system, in accordance with an embodiment of the present invention; and

FIG. 5 is a block diagram of a computing system that can perform coordinate transformation, object positioning, and hazard avoidance, in accordance with an embodiment of the present invention.

### DETAILED DESCRIPTION OF PREFERRED EMBODIMENTS

Distributed radar sensors can be used to identify information about an environment and the people and objects within it. This information can include biometric signals and high-resolution activity tracking. To accomplish this, the location of the radar sensors may be determined with precision to generate and maintain a coherent radar picture of the environment. The radar sensors may perform self-localization with respect to each other, without a need for external synchronization.

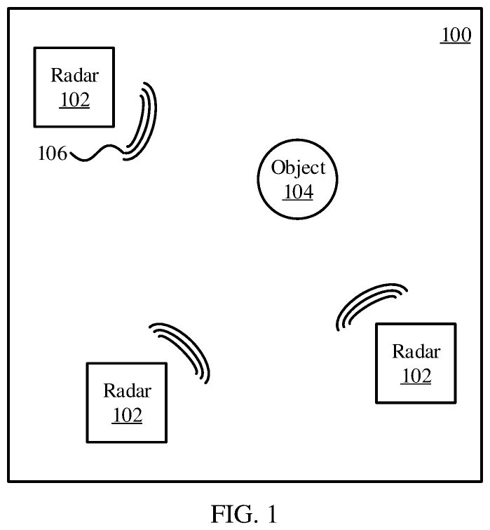

Referring now to FIG. 1, an exemplary environment 100 is shown. The environment includes multiple radar sensors 102 and an object 104. By emitting radio waves 106 and measuring the properties of the reflections of the radio waves 106 off of the object 104, each of the radar sensors 102 can determine a distance and direction from the object 104 to the respective sensor. For example, a transit time of the radio waves 106 may be measured to determine a distance of the object 104 from the radar sensor 106, while a frequency change of the radio waves 106 may be used to determine a speed of the object 104. By combining this information from multiple radar sensors 102, a location of the object 104 can be determined.

However, determining the position of the object 104 needs precise location information for the radar sensors 102. In a system that has many such radar sensors 102, manually determining precise location information for each is a time-consuming and error-prone process, particularly when the radar sensors 102 may move to different positions within the environment. In addition to location information, orientation information may be determined for the radar sensors 102, which poses a similar challenge.

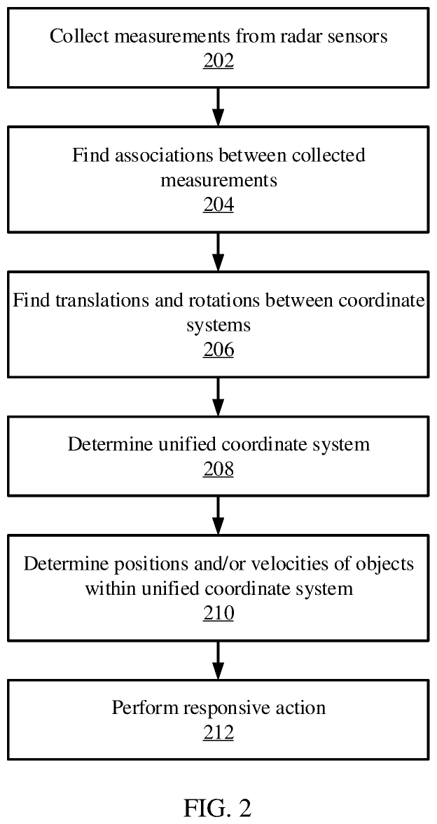

Referring now to FIG. 2, a method for determining and responding to object positions is shown. A set of radar sensors 102 The measurements may include, e.g., distance measurements that identify a distance between the radar sensor 102 and an object 104 or a part of the environment 100, as well as speed measurements that identify a speed of an object 104 within the environment 100. collects respective sets of measurements regarding their surroundings in the environment 100.

Block 204 finds associations between the collected measurements. For example, if two radar sensors collect measurements of the same object 104, these measurements can be used to help orient the radar sensors with respect to one another. Block 206 then finds translations and rotations between the respective local coordinate systems of the radar sensors 102. Based on these translations and rotations, block 208 determines a unified coordinate system that accounts for the associated radar sensors.

Using the unified coordinate system, the radar sensor measurements can be used to locate the detected object(s) within the environment 100 and determine their velocities in block 210. A responsive action can then be performed 212. For example, if an object's position indicates that it is in a dangerous area, or is liable to become a hazard itself, block 212 may sound an alarm and/or perform an automatic action to mitigate the risk, such as by shutting off a hazardous machine.

Radar sensors 102 can be used to define a coordinate system C. The term Rᵢ denotes an absolute location of radar sensor i in C, and [symbol] ᵢ denotes the local coordinate system of the radar sensor i. A virtual radar 0 may be defined such that [symbol] ₀=C. Coordinates for a node k in [symbol] ᵢ may be expressed as rₖⁱ=[xₖⁱ,yₖⁱ,zₖⁱ], where the node k may be another radar sensor in the environment 100. Thus, rₖⁱ identifies the position of node k in the coordinate system of the radar sensor i. The node k may have a speed that is equal to the directional velocity of the node k with respect to [symbol] ᵢ, but which is defined as velocity of the node k in the direction that is perpendicular to rₖⁱ. Component velocity may then be determined as:

$${d}_{k}^{i} = \frac{{( {r}_{k}^{i} )}^{T} {v}_{k}^{i}}{\vert {r}_{k}^{i} \vert}$$

where vₖⁱ is the velocity vector of the node k in [symbol] ᵢ.

The component velocity is zero if node k moves in a line that passes through the origin of [symbol] ᵢ, no matter whether the node k is moving toward or away from the origin. Otherwise, if the directional velocity is non-zero, the sign of component velocity is dₖⁱ is negative when the node k is approaching the origin and is positive when the node k is moving away from the origin.

The position rₖⁱ may be transformed as:

rₖⁱ=Hᵢⱼrₖ^{j}+(Rᵢ−Rⱼ)

where Hᵢⱼ is a rotation matrix and (Rᵢ−Rⱼ) is a linear translation. Then:

$${v}_{k}^{i} = \frac{\partial }{\partial t} {r}_{k}^{i}$$

$${v}_{k}^{i} = \frac{\partial }{\partial t} {H}_{ij} {r}_{k}^{j} = {H}_{ij} {v}_{k}^{j}$$

$${( {r}_{k}^{i} )}^{T} {v}_{k}^{i} = {( {H}_{ij} {r}_{k}^{j} + ( {R}_{i} - {R}_{j} ) )}^{T} {H}_{ij} {v}_{k}^{j} = {( {r}_{k}^{i} )}^{T} {H}_{ij}^{T} {H}_{ij} {v}_{k}^{j} + {( {R}_{i} - {R}_{j} )}^{T} {H}_{ij} {v}_{k}^{j}$$

$${d}_{k}^{i} \vert {r}_{k}^{i} \vert = {d}_{k}^{j} \vert {r}_{k}^{j} \vert + {( {R}_{i} - {R}_{j} )}^{T} {v}_{k}^{i}$$

This provides for transformation between the coordinate systems of two radar systems 102.

For two radar sensors, i and j, there is a 4-tuple defined as {(rₖ^{i(k)},rₖ^{j(k)},dₖ^{i(k)},dₖ^{j(k)})}ₖ₌₁^{K} where i(k) and j(k) are indices of the radars for the tuple k. With M radar sensors, there may be M sets of measurements in the form {(rₖⁱ,dₖⁱ)}ₖ₌₁^{K} for i=1, . . . , M, where a synchronization function Ξᵢ(k) for the tuple (rₖⁱ,dₖⁱ) indicates to which measurement the tuple belongs. Hence, if Ξᵢ(k)=Ξⱼ(k), then the tuples (rₖⁱ,dₖⁱ) and (rₖ^{j},dₖ^{j}) belong to the same object for radars i and j.

In the simple case of two radar sensors, with indices 1 and 2, a set of 2-tuple measurements {(rₖ¹,rₖ²)}ₖ₌₁^{K} is given, where K is the set of measurements that are sherd by the two radar sensors. There may be some measurements from each radar sensor that do not have a corresponding measurement in the other.

To solve the rotation matrix H₁₂, as well as the translation α=[αₓ,α_{y}]^{T}=Rᵢ−Rⱼ, the following relation may be used:

$${r}_{k}^{1} = {H}_{12} {r}_{k}^{2} + ( {R}_{1} - {R}_{2} ) = [ \begin{matrix}cos ( θ ) & sin ( θ ) \\ - sin ( θ ) & cos ( θ )\end{matrix} {r}_{k}^{2} + α ] , k - 1 , K$$

These 2K equations have three unknowns in the two dimensional case, so it is possible to use least square optimization to solve for them. However, combining the relation between cos(θ) and sin(θ) results in a nonlinear least square optimization. This can be linearized in multiple ways.

In one example, the equations may be re-written as:

$$[ \begin{matrix}{x}_{k}^{1} \\ {y}_{k}^{1}\end{matrix} ] = [ \begin{matrix}{x}_{k}^{2} & {y}_{k}^{2} & 1 & 0 \\ {y}_{k}^{2} & - {x}_{k}^{2} & 0 & 1\end{matrix} ] [ \begin{matrix}cos ( θ ) \\ sin ( θ ) \\ {α}_{1} \\ {α}_{2}\end{matrix} ] ,$$

$$k = 1 , K$$

$$Thus , s = St :$$

$$s = [ \begin{matrix}{x}_{1}^{1} \\ {y}_{1}^{1} \\ ⋮ \\ {x}_{k}^{1} \\ {y}_{k}^{1}\end{matrix} ]$$

$$S = [ \begin{matrix}{x}_{1}^{2} & {y}_{1}^{2} & 1 & 0 \\ {y}_{1}^{2} & - {x}_{1}^{2} & 0 & 1 \\ & ⋮ & & \\ {x}_{K}^{2} & {y}_{K}^{2} & 1 & 0 \\ {y}_{K}^{2} & - {x}_{K}^{2} & 0 & 1\end{matrix} ]$$

$$t = [ \begin{matrix}cos ( θ ) \\ sin ( θ ) \\ {α}_{1} \\ {α}_{2}\end{matrix} ]$$

The least square solution for t is given by t=(S^{T}S)⁻¹S^{T}s, from which the translation and rotation coefficients can be estimated. In this linear least square approach, the dependency between cos(θ) and sin(θ) is not considered, and they are treated as two independent variables. However, it is possible to solve for θ after finding the solution t by considering the dependency between these trigonometric functions.

Following the above for two measurement indices, k and l:

$$[ \begin{matrix}{x}_{k}^{1} & - {x}_{l}^{1} \\ {y}_{k}^{1} & - {y}_{l}^{1}\end{matrix} ] = [ \begin{matrix}{x}_{k}^{2} - {x}_{l}^{2} \\ {y}_{k}^{2} - {y}_{l}^{2}\end{matrix} \begin{matrix}{y}_{k}^{2} - {y}_{l}^{2} \\ - ( {x}_{k}^{2} - {x}_{l}^{2} )\end{matrix} ] [ \begin{matrix}cos ( θ ) \\ sin ( θ )\end{matrix} ]$$

$$and$$

$$cos ( θ ) = {γ}_{kl} ,$$

$$sin ( θ ) = {η}_{kl}$$

$$where$$

$$\begin{matrix}{γ}_{kl} = \frac{( {x}_{k}^{1} - {x}_{l}^{1} ) ( {x}_{k}^{2} - {x}_{l}^{2} ) + ( {y}_{k}^{1} - {y}_{l}^{1} ) ( {y}_{k}^{2} - {y}_{l}^{2} )}{{( {x}_{k}^{2} - {x}_{l}^{2} )}^{2} + {( {y}_{k}^{2} - {y}_{l}^{2} )}^{2}} \\ {η}_{kl} = \frac{( {x}_{k}^{1} - {x}_{l}^{1} ) ( {x}_{k}^{2} - {x}_{l}^{2} ) - ( {y}_{k}^{1} - {y}_{l}^{1} ) ( {y}_{k}^{2} - {y}_{l}^{2} )}{{( {x}_{k}^{2} - {x}_{l}^{2} )}^{2} + {( {y}_{k}^{2} - {y}_{l}^{2} )}^{2}}\end{matrix}$$

This leads to:

$$\begin{matrix}cos ( θ ) = \frac{1}{K} {\sum }_{k > l , ( k , l = 1 , 1 )}^{K , K} {γ}_{kl} \\ sin ( θ = \frac{1}{K} {\sum }_{k > l , ( k , l = 1 , 1 )}^{K , K} {η}_{kl}\end{matrix}$$

However, these estimates may not be consistent, such that cos²(θ)+sin²(θ)=1. Thus, the following estimate may combine both relations for cos(θ) and sin(θ). The best estimate of cos²(θ) is the mean of γₖₗ² and (1−ηₖₗ²) over all possible pairs of k and l. Equivalently, the best estimate of sin²(θ) is the mean of (1−γₖₗ²) and ηₖₗ² over all possible pairs of k and l. This produces:

$$\begin{matrix}\vert cos ( θ ) \vert = \sqrt{\frac{1}{K} {\sum }_{k > l , ( k , l = 1 , 1 )}^{K , K} ( {γ}_{kl}^{2} + 1 - {η}_{kl}^{2} )} \\ \vert sin ( θ ) \vert = \sqrt{\frac{1}{K} {\sum }_{k > l , ( k , l = 1 , 1 )}^{K , K} ( {γ}_{kl}^{2} + 1 - {η}_{kl}^{2} )}\end{matrix}$$

In some cases, the rotation of the coordinates may not be more than π/2 and working with the absolute values of the trigonometric functions is sufficient. An example of such a situation is when the radar's field of view is limited. In general, however, the radar may have a full 2π field of view, in which case the sign of the trigonometric functions is needed to find the correct rotation value. The sign can be determined from the equations above.

Given a rotation θ in two dimensions, the rotation matrix H₁₂ may be determined, and the translation vector α may be found as the mean of rₖ¹−H₁₂rₖ² taken over all values of k:

$$α = \frac{1}{K} {\sum }_{k = 1}^{K} ( {r}_{k}^{1} - {H}_{12} {r}_{k}^{2} )$$

Any of the above approaches to determining the translation and rotations may be used in block 206.

There is no benefit to using Doppler readings based on component velocities in order to refine the transformation of the coordinate systems. The component velocities dₖⁱ for i=1,2 are related to two-dimensional velocities vₖⁱ as described above. Moreover,

$${ν}_{k}^{i} = \frac{\partial }{\partial t} {H}_{ij} {r}_{k}^{j} = {H}_{ij} {ν}_{k}^{j}$$

provides two additional constraints on the velocities. Thus, for a given rotation θ, the velocities vₖⁱ may be determined.

There may be a time dependency between the measurement sets. For example, if two consecutive measurements (e.g., taken within a threshold time difference) are considered, the velocities may be regarded as roughly equal: vₖⁱ≈vₖ₊₁ⁱ. However, the same approximation will hold for corresponding component velocities, dₖⁱ≈dₖ₊₁ⁱ, as well as for estimated positions rₖⁱ≈rₖ₊₁ⁱ. Thus deploying consecutive measurements may have little benefit.

In a system of M>2 radar sensors, considering the rotation angles between coordinates provides sufficient constraints to determine the unknown velocity variables for an object. The velocities may be determined as:

$${d}_{k}^{i} = \frac{{( {r}_{k}^{i} )}^{T} {H}_{ij} {v}_{k}^{j}}{\vert {r}_{k}^{j} \vert} , i = 1 , … , M$$

where Hⱼⱼ is the identity matrix. This results in a component velocity vector:

$$d = {G}_{j} {v}_{k}^{j}$$

$$where$$

$$d = [ \begin{matrix}{d}_{k}^{1} \vert {r}_{k}^{1} \vert \\ ⋮ \\ {d}_{k}^{M} \vert {r}_{k}^{M} \vert\end{matrix} ]$$

$${G}_{j} = [ \begin{matrix}{( {r}_{k}^{1} )}^{T} {H}_{1 j} \\ ⋮ \\ {( {r}_{k}^{M} )}^{T} {H}_{Mj}\end{matrix} ]$$

By setting up a least square optimization for the velocity vectors vₖ^{j}, the linear least square solution may be obtained as:

vₖ^{j}=(Gⱼ^{T}Gⱼ)⁻¹Gⱼ^{T}d

In some cases, there may be measurements that are performed by M radars in one snapshot, where the measurement for radar I is in the form of 2-tuples {(rₖⁱ,dₖⁱ)}ₖ₌₁^{k}^{ᵢ} for i=1, . . . ,M and for some number of target measurements Kᵢ. This scenario may represent a variety of different settings, such as when a radar sensor 102 is capable of returning multiple simultaneous measurements in each time frame or snapshot. Another applicable scenario has the radar physically scan the environment and return a collective set of measurements in one batch, with the timing between radars being imperfectly synchronized but where the snapshots can be assumed to be synchronized. If each snapshot takes an exemplary 0.1 seconds, then the radars may have offsets in their measurement times within 0.1 seconds, or negligible with respect to the speed of the movement of detected objects. Thus, for the sake of measurements, one can stay that the objects are stationary in the corresponding snapshots across the different radar sensors, such that the change in relative position of the object and the speed of movement of the object is negligible compared to the timing differences. Thus there may be coarse synchronization with snapshot associations, where the association is known only for group of measurements from each radar sensor.

In one scenario, a same group of objects 104 may be detected by each of the radar sensors 102, such that Kᵢ=K, where K is the total number of objects. The translation and rotation between the local coordinates of radars i and j can be determined by taking a three-dimensional cross-correlation defined on parameters αₓ, α_{y}, and θ, where α=[αₓ,α_{y}]^{T}=Rᵢ−Rⱼ and where θ is a rotation angle between the two coordinates. However, determining this cross-correlation has a high computational complexity.

However, the shape that is generated by connecting the objects in the local coordinates is invariant to coordinate systems. The correct associations between measurements can be discovered based on that fact to convert the problem to the measurement of two-dimensional coordinates with M>2 radar sensors. A function of the node that is invariant to the rotation and translation is therefore used. Any function that is a mapping from the shape of the relative locations of the measurement points will have this invariant property.

In particular, for each radar I, the following two-dimensional matrix of distances may be used:

Cᵢ(T)={cₖₗⁱ(T)}={r_{T}ⁱ(k)−r_{T}ⁱ(l)}

where T is a vector that represents a given permutation of K elements. When T is the identity permutation, the notation Cᵢ is used for Cᵢ(T). To find the correct association of the indices k=1, . . . ,K between two radars i and j, a permutation Pᵢⱼ of 1, . . . ,K may be determined, such that Cᵢ(T)≈Cⱼ(Pᵢⱼ(T)) for an arbitrary permutation vector T=[1, . . . ,K].

For distance-based estimations, abs(Cᵢ(T)) is considered, where abs(·) returns a matrix by computing the absolute values of each element of an input matrix. The permutation Pᵢⱼ may be determined as follows. For each radar sensor I, each row of abs(Cᵢ(T)) may be sorted (e.g., in descending order) and the permutation which generates the sorted vector may be saved to calculate the matrix Eᵢ, which includes elements of the matrix Cᵢ(T) in the order of the corresponding sorted vectors for each row vector.

The matrix of sorted vectors may be given by abs(Eᵢ(T). Each matrix abs(Cᵢ(T)) for i=1, . . . ,M has K rows, and correspondences between abs(Eᵢ(T)) and abs (Cⱼ(T)) may be determined to find the association of points in the measurements by radars i and j. One solution is to find which row in abs(Eⱼ(T)) is the closest to which row of abs(Eⱼ(T)).

The vector eₖⁱ denotes the k^{th} row of the matrix Eᵢ(T). The measure of closeness between two row vectors eₖⁱ and eₗ^{j} can be defined as minimizing the norm of the vector eₖⁱ−eₗ^{j}, for example ∥eₖⁱ−eₗ^{j}∥₂ or |eₖⁱ−eₗ^{j}|, or maximizing the inner product (eₖⁱ)(eₗ^{j})^{H}, where H in this context is a Hermitian operator. In particular, if the norm of the vector eₖⁱ−eₗ^{j} is below a small, positive threshold value, or if ∥eₖⁱ(eₗ^{j})^{H}∥₂/∥eₖⁱ∥₂∥eₗ^{j}∥₂ is above a threshold value, the two vectors may be declared as a good match.

Once a match is found between two vectors eₖⁱ and eₗ^{j}, an association can be determined between all nodes in radars i and j based on corresponding permutations, which generate the sorted vectors in Eᵢ(T) from the one in Cᵢ(T). This has complexity of order O(KM) for M radars and K measurement points per snapshot. Row vectors of the matrices Eᵢ(T) and Eⱼ(T) may be considered for a pair of radars i and j, and the closest two vectors may be selected.

In angle-based estimation, a matrix Fᵢ(T) may be built from Cᵢ(T). For each row k of Cᵢ(T), denoted by cₖⁱ, the element with maximum absolute value is assigned to the first element of a vector fₖⁱ. The angle between all K−1 remaining elements of cₖⁱ may then be assigned to the vector fₖⁱ corresponding to the sorted list based on the angle between these elements and the first element of fₖⁱ. The permutation between the elements of cₖⁱ and fₖⁱ that results in the elements with sorted phases, called sorting permutation, may be saved for each of the rows. The vector fₖⁱ forms the row k of the matrix Fᵢ(T).

Each matrix Fᵢ(T) may have K rows. It may be determined which row of Fᵢ(T) corresponds to which row of Fⱼ(T) to find the association of the points in the measurement readings by the radar sensors i and j. One approach to this is to find which row vector in Fⱼ(T) is closest to which row of Fᵢ(T).

The measure of closeness between two row vectors fₖⁱ and fₗ^{j} can be defined as minimizing the norm of the angle between the vectors ∥<(fₖⁱ−fₗ^{j})∥₂, where <(·) refers to a function that computes a vector that corresponds to the component-wise angles of an input vector. The angle of an element indicates the phase of the complex number associated with the position of the element in a two-dimensional plane. The same concept can be generalized to the three-dimensional case. In particular, ∥<(fₖⁱ−fₗ^{j})∥₂ is below a small, positive threshold value, then the two vectors are identified as a good match.

With matching vectors, the associations between nodes in radars i and j may be determined based on the corresponding sorting permutations for these row vectors. This has complexity O(KM). All row vectors of the matrices Fᵢ(t) and Fⱼ(t) may be considered for radar sensors i and j, with the two closest vectors being selected.

In difference-based estimation, a matrix Fᵢ(t) is again built from Cᵢ(T) as discussed above. This may be done for all radars i=1, . . . ,M. Here the actual difference of the distances between a pair of points, represented by the corresponding elements of the row vectors fₖⁱ and fₗ^{j}, may be used instead of relying on angle. This may be interpreted as combining the angle and absolute distance measurements.

The measure of closeness between the two row vectors may be based on the distance between the individual elements of the vectors at similar positions. Two vectors are determined to be closer to one another as ∥(fₖⁱ−fₗ^{j})∥₂ grows smaller. Alternatively, the measure of closeness may be determined by maximizing ∥fₖⁱ(fₗ^{j})^{H}∥₂. In particular, if ∥(fₖⁱ−fₗ^{j}∥₂ is below a small, positive threshold, or if ∥fₖⁱ(fₗ^{j})^{H}∥₂/∥fₖⁱ∥₂∥fₗ^{j}∥₂ is above a threshold, the vectors may be regarded as a good match. The same may be generalized to the three-dimensional case.

These measures of distance may be modified if the shape that is generated by the measurements has symmetry, for example, if the points form a regular polygon or rectangle. If the shape is a regular polygon, no algorithm can return a unique rotation and translation, since there would be an ambiguity in rotations that rotate the polygon such that the resulting position of the points would return the same shape. In the case of a rectangle, there may be a unique rotation and translation between two coordinate systems, but some modifications may be needed to perform a second-level search after finding the initial match between row vectors.

In the case where an arbitrary group of objects is detected by each radar sensor 102, such that each sensor 102 may detect different objects 104, Kᵢ designates the number of objects detected by a radar sensor i. The three-dimensional cross-correlation can be used to find the translation and rotation between the local coordinate systems of radars i and j, defined on parameters αₓ, and α_{y}, and θ, where α=[αₓ,α_{y}]^{T}=Rᵢ−Rⱼ and where θ is the rotation angle between the two coordinates. However, cross-correlation has a high computational complexity.

Since each radar sensor's respective group of detected objects may not be the same, using the shape generated by connecting the location of detected objects in location coordinates may not be helpful. However, finding a function of the node that is invariant, not only to rotation and translation but also to variation in the number of measurements in each group, can be exploited. Any function that maps from the shape of the relative locations of the measurement points that are shared between two radar sensors may have such an invariance. Different subsets of measurements may be selected as an intersection of the measurements between any two radar sensors.

As above, a two-dimensional matrix of distances may be defined as Cᵢ(T)={cₖₗⁱ(T)}={r_{T}ⁱ(k)−r_{T}ⁱ(l)} for each radar i=1, . . . ,M, where T is a vector that represents a given permutation of K elements, and where Cᵢ is used when T is the identity permutation. This matrix is invariant to translation and rotation. K denotes the set of common measurements, the composition of which is not known, between radars i and j with Kᵢ and Kⱼ respectively. To find the correct associations of the indices k=1, . . . ,K between the two radars in the common measurement group, a permutation Pᵢⱼ of the elements is found such that Cᵢ(S)≈Cⱼ(Pᵢⱼ(S)), where S is a permutation vector that includes indices of the measurements in the common group.

The matrix Fᵢ(Tᵢ) may be generated from Cᵢ(Tᵢ) as discussed above, where Tᵢ is a permutation of [1, . . . ,Kᵢ]. Each row of the matrix Fᵢ(Tᵢ) is a permutation of the same row of the matrix Cᵢ(Tᵢ), where the first element has the largest absolute value among the other elements of the same row and the rest of the elements are such that the angle between the elements and the first element is in ascending order. Hence, Fᵢ(Tᵢ) can be determined for all radars i=1, . . . ,M, where the size of the matrices may be different for different radars. Next, we pick a value K for the number of common nodes where Kᵢ is smaller or equal to all Kᵢ and find the corresponding permutations Pᵢⱼ and the set of points S between all radars.

Any of the above approaches for finding the associations between the measurements of different radar sensors may be used in block 204.

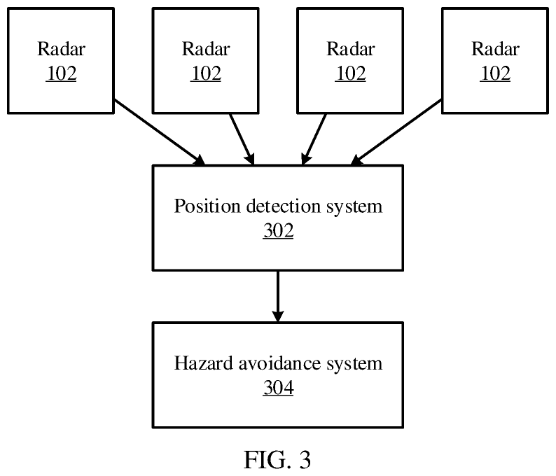

Referring now to FIG. 3, a system for detecting objects with radar sensors is shown. Multiple radar sensors 102 perform measurements and send their respective measurement data to a position detection system 302. The position detection system 302 determines a shared coordinate system and finds translations and rotations of the radar systems 102 relative to one another to find their respective positions in the shared coordinate system.

Based on this shared coordinate system, the position detection system 302 identifies a location of one or more objects 104 in an environment 100 that is monitored by the radar sensors 102. This position information may further include velocity information, which can be used to determine an action or activity being performed by the object 104.

The determined activity can be analyzed by the position detection system. For example, the activity may imply a hazard, such as when the object 104 is an individual who is entering a dangerous area, or when the object 104 is hazardous itself and poses a danger, such as a vehicle that is operating at an unsafe speed. It should be understood that the position detection system 302 may be used for any purpose, and not solely to avoid hazardous circumstances. Following this example, however, the position detection system 302 communicates with a hazard avoidance system 304, triggering an action that avoids or mitigates the harm of the hazardous activity.

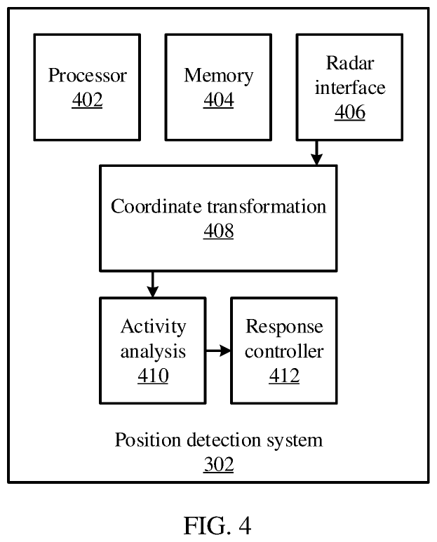

Referring now to FIG. 4, additional detail on the position detection system 302 is shown. The system 302 includes a hardware processor 402 and a memory 404. A radar interface 406 communicates with the radar sensors 102 via any appropriate wired or wireless communications protocol and medium.

The measurements received by radar interface 406 are processed in a coordinate transformation 408 to identify a shared coordinate system, including any translation and rotation needed to coordinate the measurements of one radar sensor to another. Once the measurements have been put into a shared coordinate system, they may be used to identify the position, orientation, and motion of an object. By tracking the object over time, activity analysis 410 determines an activity of the object and its status. Based on this analysis, a response controller 412 sends control signals to one or more external systems, such as a hazard avoidance system 304, to respond to the identified activity.

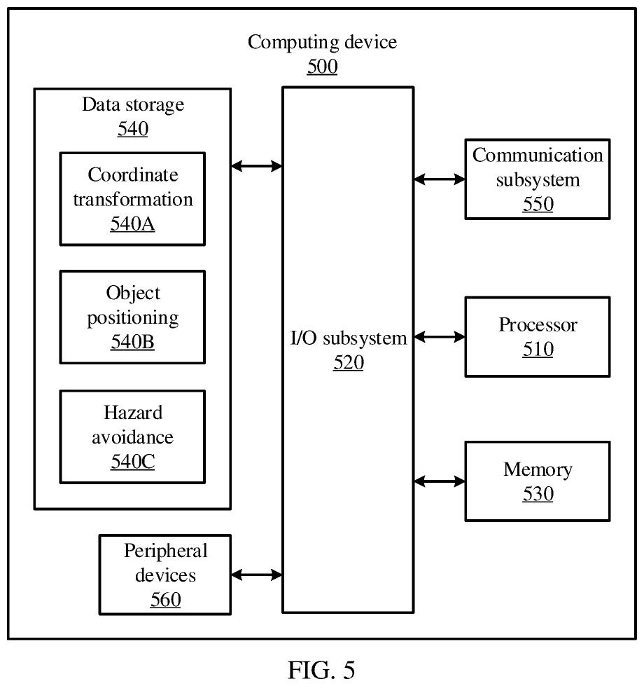

Referring now to FIG. 5, an exemplary computing device 500 is shown, in accordance with an embodiment of the present invention. The computing device 500 is configured to perform radar positioning.

The computing device 500 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 500 may be embodied as one or more compute sleds, memory sleds, or other racks, sleds, computing chassis, or other components of a physically disaggregated computing device.

As shown in FIG. 5, the computing device 500 illustratively includes the processor 510, an input/output subsystem 520, a memory 530, a data storage device 540, and a communication subsystem 550, and/or other components and devices commonly found in a server or similar computing device. The computing device 500 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 530, or portions thereof, may be incorporated in the processor 510 in some embodiments.

The processor 510 may be embodied as any type of processor capable of performing the functions described herein. The processor 510 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 530 may be embodied as any type of volatile or non-volatile memory or data storage capable of performing the functions described herein. In operation, the memory 530 may store various data and software used during operation of the computing device 500, such as operating systems, applications, programs, libraries, and drivers. The memory 530 is communicatively coupled to the processor 510 via the I/O subsystem 520, which may be embodied as circuitry and/or components to facilitate input/output operations with the processor 510, the memory 530, and other components of the computing device 500. For example, the I/O subsystem 520 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 520 may form a portion of a system-on-a-chip (SOC) and be incorporated, along with the processor 510, the memory 530, and other components of the computing device 500, on a single integrated circuit chip.

The data storage device 540 may be embodied as any type of device or devices configured for short-term or long-term storage of data such as, for example, memory devices and circuits, memory cards, hard disk drives, solid state drives, or other data storage devices. The data storage device 540 can store program code 540A for performing coordinate transformations, 540B for object positioning, and/or 540C for hazard avoidance. Any or all of these program code blocks may be included in a given computing system. The communication subsystem 550 of the computing device 500 may be embodied as any network interface controller or other communication circuit, device, or collection thereof, capable of enabling communications between the computing device 500 and other remote devices over a network. The communication subsystem 550 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 500 may also include one or more peripheral devices 560. The peripheral devices 560 may include any number of additional input/output devices, interface devices, and/or other peripheral devices. For example, in some embodiments, the peripheral devices 560 may include a display, touch screen, graphics circuitry, keyboard, mouse, speaker system, microphone, network interface, and/or other input/output devices, interface devices, and/or peripheral devices.

Of course, the computing device 500 may also include other elements (not shown), as readily contemplated by one of skill in the art, as well as omit certain elements. For example, various other sensors, input devices, and/or output devices can be included in computing device 500, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 500 are readily contemplated by one of ordinary skill in the art given the teachings of the present invention provided herein.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for object localization, comprising:
identifying associations between measurements taken from a plurality of radar sensors;
determining a shared coordinate system for the plurality of radar sensors based the identified associations, including identifying translations and rotations between local coordinate systems of the plurality of radar sensors;
determining a position of an object in the shared coordinate system, based on measurements of the object by the plurality of radar sensors; and
performing an action responsive to the determined position of the object.

2. The method of claim 1, wherein the measurements include measurements of at least one of distance and speed.

3. The method of claim 1, wherein identifying the associations includes identifying measurements of a same object from different radar sensors.

4. The method of claim 3, wherein each measurement includes a collection of K individual elements, and wherein identifying the associations includes determining a permutation of the K elements of a first measurement of a first radar sensor in accordance with the K elements of a second measurement of a second radar sensor.

5. The method of claim 4, wherein determining the permutation includes determining a distance between an element of the first measurement and an element of the second measurement.

6. The method of claim 4, wherein determining the permutation includes determining an angle between an element of the first measurement and an element of the second measurement.

7. The method of claim 1, wherein identifying the associations includes identifying coarsely synchronized measurements between radar sensors, wherein the coarsely synchronized measurements differ from one another by less than an interval between consecutive measurements of a single radar sensor.

8. The method of claim 1, further comprising detecting an activity of the object, based on multiple determinations of the position of the object.

9. The method of claim 8, further comprising determining that the activity is hazardous.

10. The method of claim 9, wherein performing the responsive action includes automatically triggering a system that mitigates or eliminates a hazard posed by the activity.

11. A system for object localization, comprising:
a hardware processor; and
a memory that stores a computer program which, when executed by the hardware processor, causes the hardware processor to:
identify associations between measurements taken from a plurality of radar sensors;
determine a shared coordinate system for the plurality of radar sensors based the identified associations, including identifying translations and rotations between local coordinate systems of the plurality of radar sensors;
determine a position of an object in the shared coordinate system, based on measurements of the object by the plurality of radar sensors; and
perform an action responsive to the determined position of the object.

12. The system of claim 11, wherein the measurements include measurements of at least one of distance and speed.

13. The system of claim 11, wherein identifying the associations includes identifying measurements of a same object from different radar sensors.

14. The system of claim 13, wherein each measurement includes a collection of K individual elements, and wherein identifying the associations includes determining a permutation of the K elements of a first measurement of a first radar sensor in accordance with the K elements of a second measurement of a second radar sensor.

15. The system of claim 14, wherein determining the permutation includes determining a distance between an element of the first measurement and an element of the second measurement.

16. The system of claim 14, wherein determining the permutation includes determining an angle between an element of the first measurement and an element of the second measurement.

17. The system of claim 11, wherein identifying the associations includes identifying coarsely synchronized measurements between radar sensors, wherein the coarsely synchronized measurements differ from one another by less than an interval between consecutive measurements of a single radar sensor.

18. The system of claim 11, further comprising detecting an activity of the object, based on multiple determinations of the position of the object.

19. The system of claim 18, further comprising determining that the activity is hazardous.

20. The system of claim 19, wherein performing the responsive action includes automatically triggering a system that mitigates or eliminates a hazard posed by the activity.
